(19) United States
(12) Patent Application Publication
(10) Pub. No.: US 2023/0137897 A1
(43) Pub. Date: May 4, 2023

(54) NON-CHLORINATED OXIDIZING ALKALINE DEGREASING GELS AND USES THEREOF

(71) Applicant: SANI-MARC INC., Victoriaville (CA)

(72) Inventors: Alexandre ROMANENS, Notre- Dame-du-Bon-Conseil (CA); Pierre-Luc AYOTTE-NADEAU, Trois-Rivière (CA); Patrick MARCHAND, Victoriaville (CA)

(73) Assignee: SANI-MARC INC., Victoriaville, QC (CA)

(21) Appl. No.: 17/976,995

(22) Filed: Oct. 31, 2022

Related U.S. Application Data
(60) Provisional application No. 63/274,254, filed on Nov. 1, 2021.

(51) Int. Cl. C11D 3/04; C11D 11/00; C11D 17/00

(52) U.S. Cl. CPC C11D 3/048; C11D 3/044; C11D 11/0041; C11D 17/003

(57) ABSTRACT

Described herein are chlorine-free alkaline degreasing compositions. The compositions comprise at least one alkaline agent, surfactant(s) and potassium nitrate. The compositions of the invention advantageously comprise potassium nitrate instead of chlorinated compound(s). In embodiments, the degreasing composition takes the form of a gel. Since the compositions are chlorine-free they are particularly useful as cleansers and degreasers in food factories. Also described are methods for transforming an original cleaning composition comprising undesirable chlorinated compound(s) into an environmental-friendly chlorine-free cleaning composition by substituting the chlorinated compound(s) by potassium nitrate.

### FIELD OF THE INVENTION

The invention relates to the field of degreasing compositions, and more particularly to alkaline gel compositions that are chlorine-free.

### BACKGROUND OF THE INVENTION

Chlorinated alkaline products have been used for a while as all-purpose degreasers in the food industry because of their alkaline and oxidizing properties. These chlorinated products have always been appreciated by users because of their effectiveness in removing deposits of organic matter such as proteins and fats, and because of their low cost. However, in recent years, new regulations and environmental considerations have led to a re-evaluation of this type of product due to the formation of undesirable harmful trihalomethane compounds. It is now well known and documented that chlorinated products are directly related to the increase of trihalomethane in drinking water and release of these compounds into the environment by wastewater treatment plants is becoming closely monitored. Since chlorinated products compose most cleansers and degreasers used in food factories, the use of these products is becoming a growing problem in the food industry. There is thus an important need to find alternatives to chlorinated products.

Potassium nitrate (KNO₃) is a crystalline salt, a strong oxidizer used especially in making gunpowder, as a fertilizer, and in medicine. Although it can be found in some complex and multi-components cleansing and degreasing compositions such as those described in Chinese patent publications CN103468203A, CN107354012A, CN103436394A, CN104711661A, CN104403850A, CN107474993A, CN107474987A, CN109136947A, potassium nitrate has never been proposed as a substituent to chlorine in cleansing and degreasing compositions. As such, no one has ever suggested or tested a degreasing aqueous composition comprising a simple combination of an alkaline agent and potassium nitrate.

Accordingly, there is a need for a chlorine-free degreasing composition that is effective in removing both, proteins and fats.

There is also a need for an environmental-friendly degreasing composition that does not yield in the production of undesirable harmful trihalomethane compounds.

There is also a need for a chlorine-free degreasing composition that takes the form of a gel. Indeed, gels typically requires less product and they also require less water for cleaning, thereby providing additional benefits both, in terms of costs and for the environment.

There is also a need for a chlorine-free degreasing composition that comprises a limited number of components and that is easy and cheap to manufacture. There is particularly a need for a degreasing composition that comprises only components that are environmentally friendly.

There is also a need in the food industry for cleansers and degreasers that can be used for cleaning tanks and piping systems, while minimizing probabilities or even eliminating completely, the release of trihalomethanes in wastewater.

The present invention addresses these needs and other needs as it will be apparent from reviews of the disclosure and description of the features of the invention hereinafter.

### BRIEF SUMMARY OF THE INVENTION

According to one aspect, the invention relates to an aqueous degreasing composition, comprising: (i) potassium nitrate; and (ii) at least one alkaline agent.

According to another aspect, the invention relates to an aqueous degreasing composition comprising:
(i) about 0% w/w to about 30 w/w anti-redeposition agent;
(ii) about 0.1% w/w to about 50 w/w of at least one alkaline agent;
(iii) about 0.01% w/w to about 50% w/w surfactant(s);
(iv) about 0.01% w/w to about 35% w/w potassium nitrate; and
(v) demineralized water to complete to 100% w/w.

According to another aspect, the invention relates to an aqueous degreasing composition consisting of:
(i) about 1% w/w to about 5% w/w anti-redeposition agent;
(ii) about 4% w/w to about 7% w/w of at least one alkaline agent;
(iii) about 7% w/w to about 12% w/w surfactant(s);
(iv) about 1% w/w to about 3% w/w potassium nitrate; and
(v) demineralized water to complete to 100% w/w.

According to another aspect, the invention relates to an aqueous degreasing composition comprising:
(i) about 0.01% w/w to about 35% w/w potassium nitrate;
(ii) about 0.01% w/w to about 50 w/w alkaline agent(s);
(iii) about 0.01% w/w to about 50% w/w surfactant(s);
(iv) about 0% w/w to about 16% w/w sequestrant(s);
(v) about 0% w/w to about 5% w/w dispersant(s); and
(vi) demineralized water to complete to 100% w/w.

According to another aspect, the invention relates to an aqueous degreasing composition consisting of:
(i) about 1% w/w to about 3% w/w potassium nitrate;
(ii) about 8% w/w to about 12 w/w alkaline agent(s);
(iii) about 12% w/w to about 16% w/w surfactant(s);
(iv) about 0.5% w/w to about 2% w/w sequestrant(s);
(v) about 0.5% w/w to about 2% w/w dispersant(s); and
(vi) demineralized water to complete to 100% w/w.

According to another aspect, the invention relates to a method of degreasing a surface, comprising contacting the surface with an aqueous degreasing composition as defined herein.

According to another aspect, the invention relates to a kit for degreasing a surface, the kit comprising:

a degreasing composition as defined herein; and

at least one additional component selected from the group consisting of a user manual or instructions, a spray bottle, a mixing bottle, pen(s), marking sheets, boxes, holders, wipes, and cleaning solutions.

According to another aspect, the invention relates to a method for transforming an original cleaning composition comprising undesirable chlorinated compound(s) into an environmental-friendly chlorine-free cleaning composition, the method comprising substituting said chlorinated compound(s) by potassium nitrate.

According to another aspect, the invention relates to a method for making an environmental-friendly cleaning composition from an existing cleaning composition comprising chlorinated compound(s), the method comprising substituting said chlorinated compound(s) by potassium nitrate.

According to another aspect, the invention relates to a method for making an oxidizing alkaline cleaning composition, comprising preparing an aqueous solution comprising potassium nitrate and least one alkaline agent.

According to another aspect, the invention relates to a method of degreasing an enclosed surface of a piping system, the method comprising circulating into said piping system a composition according as defined herein, wherein said circulating is carried out for a period of time providing for removal of fats and proteins from said enclosed surface.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE DRAWINGS (OR FIGURES)

In order for the invention to be readily understood, embodiments of the invention are illustrated by way of example in the accompanying figures.

FIG. 1 is a panel with pictures showing results of a cleaning test of a soil of milk proteins, in accordance with Example 1. Chloragel™ 3%: A) soiled plates prior treatment; B) same plates after treatment. NOA without chlorine 3%: C) soiled plates prior treatment; D) same plates after treatment.

FIG. 2 is a bar graph showing calculated soil removal efficacy at 25° C. of a soil comprising proteins and fats, using Chloragel™ and concentrated and diluted solutions of NOA original, in accordance with Example 1.

FIG. 3 is a bar graph showing calculated soil removal efficacy at 4° C. of a soil comprising proteins and fats, using Chloragel™ and concentrated and diluted solutions of NOA original, in accordance with Example 1.

FIG. 4 is a bar graph showing calculated soil removal efficacy at 4° C. of a soil comprising proteins and fats, using Versagel™ and concentrated and diluted solutions of NOA Soft Metal, in accordance with Example 1.

FIG. 5 is a bar graph showing calculated soil removal efficacy at 25° C. of a soil comprising proteins and fats, using Versagel™ and concentrated and diluted solutions of NOA Soft Metal, in accordance with Example 1.

FIG. 6 is a line graph showing viscosity curves for Versagel™ and NOA Soft Metal in water having a hardness of 200 ppm.

FIG. 7 is a line graph showing viscosity curves for Versagel™ and NOA Soft Metal in water having a hardness of 400 ppm.

FIG. 8 is a line graph showing viscosity curves for Chloragel™ and NOA original in water having a hardness of 200 ppm.

FIG. 9 is a line graph showing viscosity curves for Chloragel™ and NOA original in water having a hardness of 400 ppm.

Further details of the invention and its advantages will be apparent from the detailed description included below.

### DETAILED DESCRIPTION OF EMBODIMENTS

In the following description of the embodiments references to the accompanying figures are illustrations of an example by which the invention may be practiced. It will be understood that other embodiments may be made without departing from the scope of the invention disclosed.

### Degreasing Compositions

According to one aspect, the invention relates to a composition comprising:
(i) potassium nitrate; and (ii) at least one alkaline agent.

The composition of the invention is a “degreasing composition”. That term refers to a composition that has been devised for degreasing purposes, i.e., for removal of (preferably removal of both) fats and/or proteins that may be present on surfaces.

As used herein the term “potassium nitrate” refers to the compound of formula KNO₃. The compound may also be defined by its CAS number 7757-79-1.

As used herein the term “alkaline agent” refers to a compound having strong base. Those skilled in the art can readily identify alkaline agents that may be useful in accordance with the present invention. In embodiments the alkaline agent is selected from sodium hydroxide (NaOH), potassium hydroxide (KOH), disodium metasilicate (Na₂SiO₃, e.g. Metso®), ammonium hydroxide (NH₄OH), magnesium hydroxide (Mg(OH)₂), sodium tetraborate (Borax; Na₂[B₄O₅(OH)₄].8H₂O), sodium bicarbonate (NaHCO₃), sodium carbonate (Na₂CO₃), triethanolamine (C₆H₁₅NO₃), monoethanolamine (C₂H₇NO), calcium hydroxide (Ca(OH)₂), lithium hydroxide (LiOH) and ammonia (NH₃).

As used herein the term “anti-redeposition agent” refers to an ingredient that keeps soil particles suspended in a wash liquor so they do not get deposited back on a surface. Anti-redeposition agent are commonly used in laundry detergents to help prevent soil from resettling on fabrics after it has been removed during washing. Those skilled in the art can readily identify anti-redeposition agents that may be useful in accordance with the present invention. A non-exhaustive list of anti-redeposition agents include for instance liquid detergent polymers such as Acusol™ 445, sodium carboxymethyl cellulose (CMC), methylcellulose, polyvinylpyrrolidone (PVP), polyvinyl alcohol, polyethylene glycol (PEG), polyacrylic acid polymer, and acrylic/maleic co-polymer.

The potassium nitrate and at least one alkaline agent are present in the composition in amounts sufficient to provide effective degreasing properties (e.g., removal of fats and proteins) and also in amounts not to high to be too corrosive to metals, particularly as soft metals.

In embodiments, the composition of the invention is referred herein as “NOA Original” and it comprises fat removal properties such that a diluted formulation of the degreasing composition (e.g. 3% v/v) can remove of at least 40% of the fat content of a soil when contacted with the soil without agitation for 5 min at 4° C. (i.e. better results compared to the commercial solution Chloragel™ with less than 39% removal), and can remove of at least 55% of the protein content of soil when contacted with the soil without agitation for 5 min at 25° C. (i.e. better than Chloragel™ with less than 52% removal).

In embodiments, the composition of the invention is referred herein as “NOA Original” and it comprises protein removal properties such that a diluted formulation of the degreasing composition (e.g. 3% v/v) can remove of at least 50% of the protein content of a soil when contacted with the soil without agitation for 5 min at 4° C. (i.e. better results compared to the commercial solution Chloragel™ with less than 43% removal), and can remove of at least 55% of the protein content of soil when contacted with the soil without agitation for 5 min at 25° C. (i.e. better than Chloragel™ with about 45% removal).

In embodiments, the composition of the invention is referred herein as “NOA Soft Metal” and it comprises fat removal properties such that a diluted formulation of the degreasing composition (e.g. 3% v/v) can remove of at least 68% of the fat content of a soil when contacted with the soil without agitation for 5 min at 4° C. (i.e. better results compared to the commercial solution Versagel™ with about 63% removal), and can remove of at least 84% of the protein content of soil when contacted with the soil without agitation for 5 min at 25° C. (i.e. better than Versagel™ with less than 79% removal).

In embodiments, the composition of the invention is referred herein as “NOA Soft Metal” and it comprises protein removal properties such that a diluted formulation of the degreasing composition (e.g. 3% w/w) can remove about 66% of the protein content of a soil when contacted with the soil without agitation for 5 min at 4° C. (i.e. better results compared to the commercial solution Versagel™ with about 63% removal), and can remove of at least 64% of the protein content of soil when contacted with the soil without agitation for 5 min at 25° C. (i.e. better than Versagel™ with about 61% removal).

In particular embodiments the composition comprises about 0.1% w/w to about 10% w/w, or about 0.5% w/w to about 5% w/w, or about 1.5% w/w to about 4% w/w, or about 2% w/w potassium nitrate.

In particular embodiments the composition comprises about 0.01% w/w to about 50% w/w, or about 1.0% w/w to about 30% w/w, or about 50% w/w to about 15% w/w, or about 11% w/w of the at least one alkaline agent.

In particular embodiments the composition comprises about 0.01% w/w to about 30% w/w, or about 1.0% w/w to about 15% w/w, or about 2% w/w to about 10% w/w, or about 2.5% w/w of the at least one anti-redeposition agent.

In embodiments, the degreasing composition of the invention comprises a reduced or low corrosive impact (i.e. about 1 mm/year or less). In embodiments a plate of soft metal (e.g. stainless steel, aluminum, copper, galvanized steel) immersed for 24 h in a diluted formulation of the degreasing composition (e.g. diluted at 3% v/v) has a reduced weight loss of about 0.8 mm/year, or about 0.5 mm/year, or about 0.1 mm/year, or about 0.05 mm/year, or about 0.01 mm/year, or about 0.005 mm/year, or about 0.001 mm/year, or about 0.0005 mm/year, or about 0.0001 mm/year, or lower. In embodiments, the weight loss caused by the diluted 3% v/v degreasing composition of the invention is comparable to that of comparative commercial solutions as Chloragel™ and Versagel™ diluted as well at 3% v/v.

In embodiments, the composition of the invention further comprises at least one compound selected from a surfactant, an anti-redeposition agent, a rheology agent, a foaming agent, an anti-corrosive agent, and a bactericide.

Preferably the surfactant is a non-foaming surfactant. Non-foaming surfactant may be preferable in order to avoid undesirable fluctuations of pressure in piping systems that may occur when using foaming cleaning compositions.

The surfactant used in the present formulations may be anionic, cationic or non-ionic. In embodiments, the surfactant is an anionic surfactant. In embodiments, the surfactant is a non-ionic surfactant.

Examples of anionic surfactants include, but are not limited to, those members of the following classes of chemical compounds: alkyl sulfates, alkylethoxylated sulfates, alkyl aromatic sulfonates, alkyl sulfosuccinates, dialkyl sulfosuccinates, alkylethoxylated sulfosuccinates, dialkylethoxylated sulfosuccinates. Specific examples include: sofium lauryl sulfate, sofium lauryiethoxy sulfate, sofium dofecylbenzene sulfonate, disofium 2-ethylhexyl sulfosuccinate, sodium lauryl sulfosuccinate, sofium lauryiethoxy sulfosuccinate.

Examples of non-ionic surfactants include, but are not limited to, those members of the following classes of chemical compounds: alkyl ethoxylates, alkylaryl ethoxylates, ethylene oxide/propylene oxide diblock and triblock surfactants both linear and branched.

In some embodiments the non-foaming surfactant is selected from the group consisting of Tergitol™ L-62™, Antarox™ L61, Antarox™ LA-EP-16, Triton™ DF-12, Triton™ DF-16, Plurafac™ SL F180, Pluronic™ 462 D, Hartopol™ 25R2, Mirataine™ ASC, Akypo™ LF-2, Akypo™ LF-4 and combinations thereof.

In embodiments the surfactant is one or more or sulfonic acid, sodium xylene sulfonate, Ammonyx™ MO. In embodiments the composition comprises about 0.01% w/w to about 50% w/w, or about 1.0% w/w to about 30% w/w, or about 5% w/w to about 20% w/w, or about 15% w/w of the surfactant.

A single surfactant of the types listed above may be used in the compositions of the invention. Alternatively, compositions that include multiple surfactants are also considered as within the scope of this present invention. The examples of surfactants listed above are not an exhaustive list of the surfactants that may be used in the present invention. One skilled in the art will recognize additional members and variations within the various categories listed above. Such additional compounds are considered to be within the scope of the present invention.

In embodiments the anti-redeposition agent is selected from liquid detergent polymers (e.g. a poly(acrylic acid sodium salt) such as Acusol™ 445), sodium carboxymethyl cellulose (CMC), methylcellulose, polyvinylpyrrolidone (PVP), polyvinyl alcohol, polyethylene glycol (PEG), polyacrylic acid polymer, and acrylic/maleic co-polymer. In embodiments, the composition comprises about 0.01% w/w to about 30% w/w, or about 1% w/w to about 15% w/w, or about 2% w/w to about 10% w/w, or about 6% w/w of the anti-redeposition agent. In embodiments the anti-redeposition agent comprises Acusol™ 445.

According to one embodiment, the composition comprises the following proportions of ingredients, as defined in Table 1:

TABLE 1
Examples of concentrations for NOA Original

| | Range |
|---|---|
| Role | (% w/w) |
| Potassium nitrate | 0.01-35 |
| Alkaline agent(s) | 0.01-50 |
| Anti-redeposition agent(s) | 0-30 |
| Surfactant(s) | 0.01-50 |
| Fragrance | 0-1 |
| Sequestrant(s) | 0-10 |
| Others | 0-80 |
| Demineralized water | to complete to 100% |

According to another embodiment, the composition comprises the following proportions of ingredients, as defined in Table 2:

TABLE 2
Examples of concentrations for NOA Soft Metal

| | Range |
|---|---|
| Role | (% w/w) |
| Potassium nitrate | 0.01-35 |
| Alkaline agent(s) | 0.01-50 |
| Surfactant(s) | 0.01-50 |
| Sequestrant(s) | 0-10 |
| Fragrance | 0-1 |
| Dispersant(s) | 0-5 |
| Others | 0-75 |
| Demineralized water | (to complete to 100%) |

The composition of the present invention may additionally contain one or more anti-microbial agents, including but not limited to non-cationic anti-microbial agents. The non-cationic anti-microbial agents may be phenolics, halogenated phenolics, halogenated diphenyl ethers, halogenated carbonilides, water soluble or water insoluble peroxy oxidizing agents, for example, peroxides, peresters, peracids, percarbonates, persulfates or mixtures thereof.

The composition of the present invention may optionally contain a low molecular weight alcohol. As used herein, “low molecular weight alcohol” means, an alkyl alcohol wherein the alkyl group contains from one to eight carbon atoms. Specific examples include butyl alcohol, propyl alcohol, ethyl alcohol, methyl alcohol and 2-Butoxyethanol (butyl cellosolve).

The composition of the present invention may also include other additives, such as fragrance, colors, inorganic salts, inorganic acids, sequestrants, organic solvents, fillers, rheology modifiers, and thickeners.

Tables 3 and 4, hereinafter provide an example of a degreasing composition in accordance with a particular embodiment of the present invention identified as “NOA Original”, a composition inspired by the commercial product Chloragel™. Tables 5 and 6, provide an example of a degreasing composition in accordance with a particular embodiment of the present invention identified as “NOA Soft Metal” that was inspired by the commercial product Versagel™

TABLE 3
Composition of NOA Original vs. Chloragel ™

| | | | NOA |
|---|---|---|---|
| | CAS | Role in both | Original |
| Name | Number | formulations | (% w/w) |
| Demineralized water | 7732-18-5 | Solvent | 81.69 |
| Poly(acrylic acid sodium | 9003-04-07 | Anti- | 2.73 |
| salt) | | redeposition | |
| | | agent | |
| Potassium hydroxide | 1310-58-3 | Alkaline | 5.07 |
| | | agent (base) | |
| Sodium | 1300-72-7 | Surfactant | 3.97 |
| xylenesulphonate | | | |
| Alkyl (C10-C16) | 68584-22-5 | Surfactant | 1.88 |
| benzene sulfonic acid | | | |
| N,N- | 3332-27-2 | Surfactant | 2.66 |
| dimethyltetradecylamine | | | |
| N-oxide | | | |
| Sodium hypochlorite, | 7681-52-9 | Oxidant | N/A |
| solution | | | |
| Fresh scent | N/A | Fragrance | N/A |
| Potassium Nitrate | 7757-79-1 | Oxidant | 2.00 |

The following properties (Table 4) were measured for the solution NOA Original:

TABLE 4
Properties of the formulation NOA Original

| | | | | |
|---|---|---|---|---|
| Appearance | Liquid | Density (g/mL) | 1.04-1.16 | |
| Color | colorless | % of solid (w/w) | 17.0-20.0 | |
| Odour | Caustic | Total alkalinity | 5.10-5.50 | mL |
| pH | 12.60-13.90 | | | |
| RI* | 19.75-20.25 | | | |

TABLE 5
Composition of NOA Soft Metal vs. Versagel ™

| | | | NOA Soft |
|---|---|---|---|
| | CAS | Role in both | Metal |
| Name | Number | formulations | (% w/w) |
| demineralized water | 7732-18-5 | Solvent | 72.59 |
| Alkyl (C10-C16) benzene | 68584-22-5 | Surfactant | 1.99 |
| sulfonic acid | | | |
| N,N-dimethyltetradecylamine | 3332-27-2 | Surfactant | 2.75 |
| N-oxide | | | |
| Sodium xylenesulphonate | 1300-72-7 | Surfactant | 9.15 |
| Tetrasodium salt of ethylene- | 64-02-8 | Sequestrant | 1.01 |
| diaminetetraacetic acid | | | |
| 1-Hydroxyethane-1,1,- | 2809-21-4 | Dispersant | 1.06 |
| diphosphonic acid | | | |
| Sodium Hydroxide 50% | 1310-73-2 | Alkaline | 0.66 |
| | | agent (base) | |
| Disodium metasilicate | 6834-92-0 | Alkaline | 8.80 |
| | | agent (base) | |
| Potassium Nitrate | 7757-79-1 | Oxidant | 2.00 |

The following properties (Table 6) were measured for the solution NOA Soft Metal:

TABLE 6
Properties of the formulation NOA Soft Metal:

| | | | | |
|---|---|---|---|---|
| Appearance | Liquid | Density (g/mL) | 1.05-1.17 | |
| Color | yellowish | % of solid (w/w) | 22.0-26.0 | |
| Odour | caustic | Total alkalinity | 5.60-6.00 | mL |
| pH | 12.20-13.50 | | | |
| RI | 27.25-27.75 | | | |

The compositions of the invention may be formulated as a ready-to-use (RTU) solution (i.e., as defined hereinabove) or as a liquid concentrate (e.g., 2×, 3×, 4×, 5×, 10×, 50× etc.) for further dilution with water or water-based solutions including, but not limited to, alkaline or neutral cleaning solutions.

In embodiments, the compositions of the invention are diluted prior use, e.g. they are diluted to concentration corresponding to about 1% v/v, about 2% v/v, about 2.5% v/v, or about 3% v/v, or about 3.5% v/v, or about 4% v/v, or about 4.5% v/v, or about 5% v/v, or about 6% v/v, or about 7% v/v, or about 8% v/v, or about 9% v/v, or about 10% v/v, or at lower or at higher dilutions.

The compositions of the invention could also possibly be formulated as a powder for later dissolution in a suitable aqueous solution (e.g., water). For a composition formulated as a liquid and/or solid, required ingredients may be mixed with a predetermined volume of filtered or distilled water. If necessary, the resulting mixed solution may be adjusted to the desired pH by addition of suitable acidifying or alkaline agents.

In embodiments, the degreasing composition of the invention takes the form of a gel. Indeed, it typically requires less cleansing product when the product is a gel because gels have more adherence to soiled surfaces than liquid. As such the cleaning requires less water as well. Accordingly, a gel provides additional benefits in terms of costs of goods, and also additional benefits for the environment (i.e. less product and less wastewater).

In embodiments, a diluted formulation (e.g., 5% v/v) of the degreasing composition of the invention (e.g., NOA SoftMetal) comprises a viscosity of about 108 centistoke (cSt) in water having 200 ppm hardness (compared to 125 cSt for the commercial solution Versagel™ (diluted at 5% v/v)) and about 96 cSt in water having 400 ppm hardness (compared to 101 cSt for the commercial solution 5% v/v Versagel™)

In embodiments, a diluted formulation (e.g., 6% v/v) of the degreasing composition of the invention (e.g., NOA Original) comprises a viscosity of about 135 centistokes (cSt) in water having 200 ppm hardness (compared to about 18 cSt for the commercial solution Chloragel™ (diluted at 6% v/v)) and about 80 cSt in water having 400 ppm hardness (compared to about 4 cSt for the commercial solution 6% v/v Chloragel™)

In embodiments, a diluted formulation (e.g., 5% v/v) of the degreasing composition of the invention (e.g., NOA Original) comprises a viscosity of about 101 centistoke (cSt) in water having 200 ppm hardness (compared to about 24 cSt for the commercial solution Chloragel™ (diluted at 5% v/v)) and about 107 cSt in water having 400 ppm hardness (compared to about 20 cSt for the commercial solution 5% v/v Chloragel™)

The compositions of the present invention containing the various components indicated hereinabove may also be in the form of a foam, a viscous liquid, a liquid soap, a pasty mixture (e.g., a heavy-duty soap used by mechanics), or a semi-solid or a solid (e.g., a bar of soap).

The form or physical appearance of the compositions in accordance with the present invention may be adapted according to desired uses) and that form or appearance will generally depend on the content of the formulation, and the present invention contemplates all of such forms or appearances, to the extent the form or appearances do not affect substantially the fat removal properties and/or the protein removal properties of the degreasing composition of the invention.

### Methods and Uses

According to additional aspects, the invention relates to the uses of the compositions according to the present invention, particularly for degreasing surfaces.

In embodiments the compositions are used in methods for the removal of fats and/or removal of fatty soils, including, but not limited to, triglycerides, greases, oils, fats from plants and/or animal sources such as milk, eggs, meats, fishes, soya, seeds and nuts.

In embodiments the compositions are used in methods for the removal of proteins and/or removal of proteinic soils, including, but not limited to, proteins from plants and/or animal sources such as milk, eggs, blood, meats, fishes or semi-liquid food such as beer, juice puree, vegetable purée and jam, proteins from soya, seeds and nuts, proteins such as casein, albumin, ovalbumin, etc.

According to one particular aspect, the invention relates to a method of degreasing from a surface, such as an enclosed surface of a piping system that may comprise pipes, vessels, process equipment, filters, membranes, heat exchangers, valves and/or associated fittings.

In embodiments, the methods of the invention allow to clean and/or degrease different types of surface including, but not limited to, stainless steel, aluminum, copper, galvanized steel, glass (e.g. borosilicate), plastics and Teflon™. In embodiments the surface is in an interior surface of a pipe or of a vessel (e.g., smooth stainless steel surface).

In one embodiment, the method comprises contacting a soiled surface with a degreasing composition as defined herein for a period of time sufficient to provide a successful disruption and/or removal the soil. In embodiments, the contacting is carried out for at least 15 s, or at least 30 s, or at least 1 minute, or at least 2 min, or at least 3 min, or at least 4 min, or at least 5 minutes, or at least 10 minutes, or at least 15 minutes, or at least 20 minutes, or at least 25 minutes, or at least 30 minutes, or at least 45 minutes, or at least 60 minutes or more. Typically, a longer period of time may be preferred to achieve better cleansing and/or if there are more soils but it is within the skills of those in the art to determine an acceptable period of time providing for obtaining a desired efficacy.

According to another particular aspect, the invention relates to a clean-in-place (CIP) system for cleaning an enclosed surface of pipes and/or vessels. In one embodiment the CIP system comprises a supply container for receiving a useful volume of solution and said supply container comprises a degreasing composition as defined herein. Preferably for such use the solution is in the form of a liquid.

In embodiments, the methods of the present invention find uses in degreasing and/or cleansing various soiled surfaces that may be found in slaughterhouses, hospitals, kitchens, fruit and vegetable industries, food and beverage industries, etc. In embodiments, the methods of the present invention find uses in degreasing and/or cleansing soiled surfaces such as floor, walls, equipment, tools, pipes, vessels, tanks, reservoirs, and the like.

In particular embodiments, the methods of the present invention find uses in degreasing and/or cleansing of piping systems that are used in the production of food products, including but not limited to meat, milk, beer, juice puree, vegetable puree and jam.

### Kits

A further aspect of the invention relates to kits. The kits of the invention may be useful for the practice of the methods of the invention, particularly for degreasing surfaces and/or for cleaning an enclosed surface comprising pipes and/or vessels.

A kit of the invention may comprise one or more of the following components: (i) a degreasing composition as defined herein; and (ii) at least one additional component, including but not limited to: a user manual or instructions, a spray bottle, a mixing bottle, pen(s), marking sheets, boxes, holders, wipes, and cleaning solutions, etc. In embodiments, the kit the composition of the invention may possibly be provided in a powder form. The composition and/or additional solutions may also be formulated as a liquid concentrate to be diluted prior use (e.g. diluted at a final diluted concentration of 1%, 2% 3%, 4%, 5%, 6%, 7%, etc.).

### Methods of Using Potassium Nitrate

As described herein and demonstrated in the Exemplification hereinafter, potassium nitrate has been found to be a component of choice for replacing chlorinated compounds in existing commercial degreasing compositions such as Chloragel™ and Versagel™

Accordingly, a further aspect of the invention relates to a method for transforming a composition comprising undesirable chlorinated compound(s) into an environmental-friendly chlorine-free composition. In one embodiment the method comprises substituting the chlorinated compound(s) by potassium nitrate. In embodiments, the original composition is an oxidizing alkaline composition. In embodiments, the original composition and/or the environmental-friendly chlorine-free composition is(are) effective in removing proteins and fats from a surface. In embodiments, the original composition and/or the environmental-friendly chlorine-free composition is(are) a degreasing composition. In embodiments, the original and/or the environmental-friendly chlorine-free composition is(are) for cleaning pipes, vessels, process equipment, filters, membranes, heat exchangers, and/or associated fittings used in the production of food products. In embodiments, the environmental-friendly chlorine-free composition comprises about 1.0% w/w to about 35.0% w/w potassium nitrate.

A related aspect concerns a method for making an environmental-friendly composition from an existing composition that comprises chlorinated compound(s). In one embodiment the method comprises substituting the chlorinated compound(s) in the existing composition by potassium nitrate. Examples of chlorinated compound(s) that may be substituted includes, but are not limited to, sodium hypochlorite, calcium hypochlorite, chlorine dioxide, sodium dichloroisocyanurate, trichloroisocyanuric acid.

Another related aspect concerns a method for making an oxidizing alkaline composition. In one embodiment the method comprises preparing an aqueous solution comprising potassium nitrate and least one alkaline agent. In one embodiment, the composition comprises about 1.0% w/w to about 10% w/w of potassium nitrate, and about 5.0% w/w to about 20.0% w/w of the alkaline agent. In embodiments, the oxidizing alkaline composition is free of chlorine including, but not limited to, sodium hypochlorite, sodium hypochlorite, calcium hypochlorite, chlorine dioxide, sodium dichloroisocyanurate, trichloroisocyanuric acid.

Those skilled in the art will recognize, or be able to ascertain, using no more than routine experimentation, numerous equivalents to the specific procedures, embodiments, claims, and examples described herein. Such equivalents are considered to be within the scope of this invention and covered by the claims appended hereto. The invention is further illustrated by the following examples, which should not be construed as further or specifically limiting.

### EXAMPLES

### Example 1: Cleaning Tests

As it is known in the art, it is possible to determine cleaning efficiency of a solution by assessing cleanliness level after a certain cleaning treatment with that solution. Typically, degree of cleanliness is based on the amount of organic material (protein, fat, blood) that have been removed or that remains present on a surface after a cleaning treatment.

Accordingly, a series of tests were carried out to test the efficacy of oxidizing alkaline cleaning solutions in accordance with the present invention in the removal of fats and proteins from metallic surfaces. These tests were carried out at room temperature (i.e. about 25° C.) as well as at 4° C. in order to simulate a typical user's cleaning experience in the food industry.

Greasy soiling tests were done using Crisco™ grease (about 12% fat content) or a Greek yogurt (about 8% protein and about 8% fat content). 200 mg of each soil was deposited on plates and dried with an air gun for 1 min at 35° C.

The dried soiled plates were next immersed in 50 ml Falcon™ tubes containing 40 ml of various concentrated or diluted (3% w/w) washing solutions at 4° C. or 25° C. The plates were incubated in tubes at 4° C. or 25° C. for 5 min without stirring. After the incubation period, the plates were rinsed with a low flow of cold demineralized water for 10 sec. Next, the plates were air dried for 24 hours and weighed.

The dried plates were analyzed by image analysis using Fiji™ Image J™ software. Briefly, pictures of the plates were taken and the images were transformed for 8 bits for binary calculation. Black pixels representing the organic material were assigned a value of 0 whereas a value of 255 was assigned to white pixels representing a fully cleaned surface. The threshold was adjusted to a value showing all (or almost all) visible pixels on the plate. The measured values were used for calculating percentages of soil removal for each treatment and these percentages were displayed in bar graphs. The results presented are means of the measurements of two separate tests, each test carried out with triplicates soiled samples.

Chloragel™ and Protein Soiling Tests

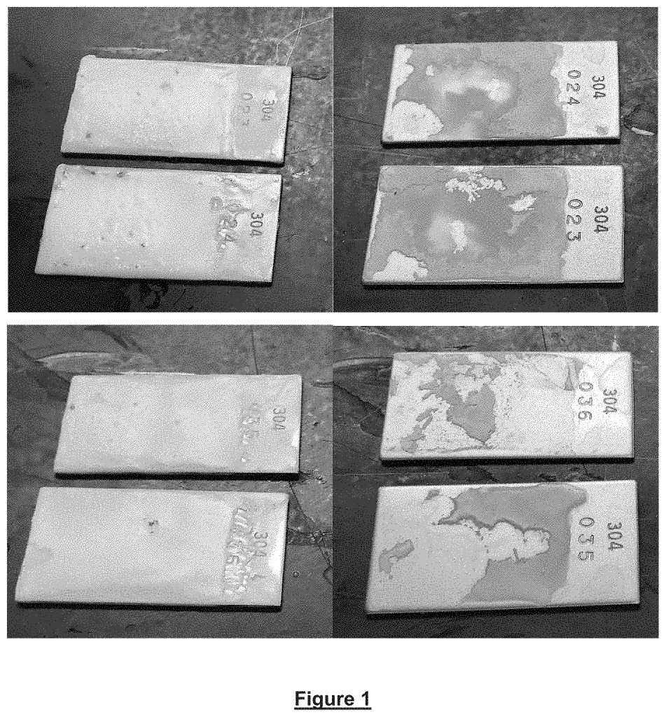

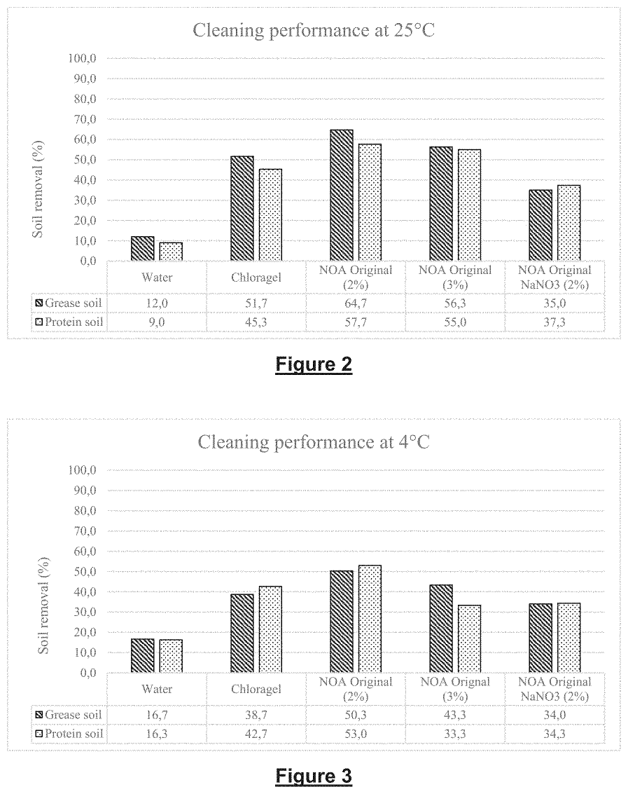

As shown in FIGS. 1, 2 and 3 the cleaning efficacy of the formulation comprising potassium nitrate (i.e., NOA Original) is comparable to the original formulation containing sodium hypochlorite (Chloragel™). When diluted at a concentration of 3%, Chloragel™ achieved a cleaning rate of between 45% and 51% at 25° C. (FIG. 2) and 42% to 38% at 4° C. for protein and grease soil respectively (FIG. 3). At this same concentration, NOA Original 2% (2% of KNO₃ in concentrate) achieved a cleaning rate about 10% higher than Chloragel™, no matter the temperature (57% and 64% at 25° C. (FIG. 2) and 53% to 50% at 4° C. for protein and grease soil respectively (FIG. 3). Therefore, at a same concentration, NOA Original will remove more soils than Chloragel™. Alternatively, NOA Original may be used at a greater dilution (i.e., lower concentration) and be able to achieve the same efficiency than Chloragel™. Therefore, it would require less product to clean a plant with NOA Original than with Chloragel™. At a low temperature of 4° C., both products lost about 25% of their efficiency, but NOA Original maintained its advantage. Increasing concentration of KNO₃ to 3% in the concentrate (i.e. NOA Original 3%) did not improve the cleaning efficiency compare to the NOA Original 2%. Replacing potassium nitrate (i.e., NOA Original 2%) with sodium nitrate (i.e. NOA Original NaNO₃ (2%)), was not beneficial since a decrease of about 30% in efficiency above 30% was observed in the latter.

Versagel™

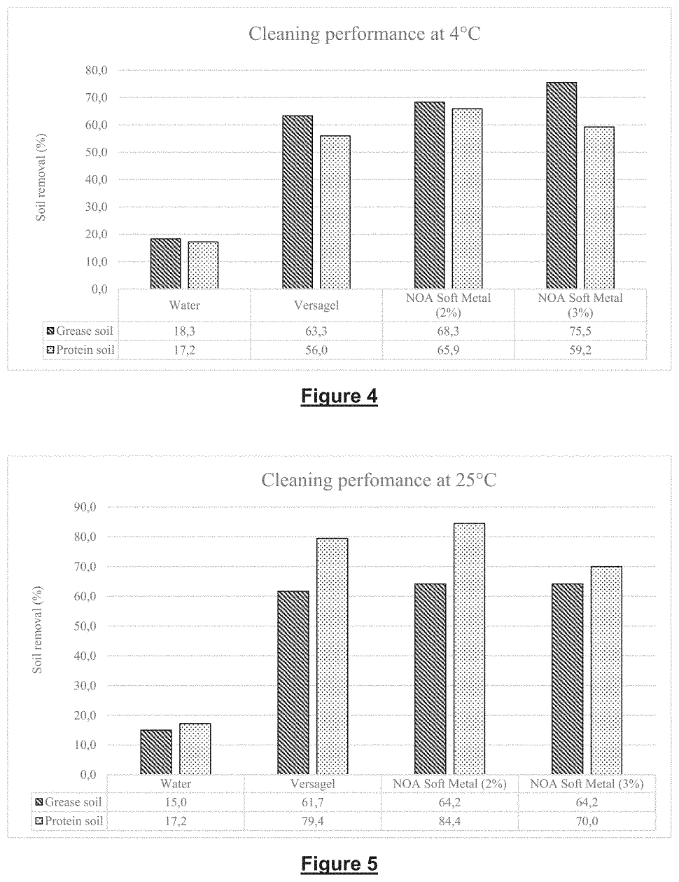

Results of the greasy soiling tests using diluted solutions of Versagel™ and NOA Soft Metal are shown in FIG. 4 and FIG. 5. Both products were diluted at 3%. Versagel™ achieved a cleaning efficiency of between 61% and 79% at 25° C. on protein and grease respectively. At 4° C., Versagel™ achieved a cleaning efficiency of between 56% and 63%, on protein and grease soil. Diluted solutions of NOA Soft Metal (NOA Soft Metal (2%), and NOA Soft Metal (3%)) were the most effective. At 25° C., NOA Soft Metal 2% (i.e. containing 2% of potassium nitrate in concentrate) achieved a soil removal cleaning efficiency of 84% on a protein soil and 64% on grease soil. At 4° C., the soil removal cleaning efficiency was 65% for protein and 68% for grease using NOA Soft Metal 2%. Concerning NOA Soft Metal 3%, its efficiency was better on fat deposits at 20° C. compared to NOA Soft Metal 2%, but its efficiency was lower on protein deposits. At 4° C., this same trend was reversed: NOA Soft Metal 3% had a better efficiency on fat deposits than protein deposits compared to NOA Soft Metal 2%. In all cases, NOA Soft Metal 2% was more effective than Versagel™, regardless of the temperature.

### Example 2: Viscosity

There are several advantages in using a gel over a foam product for cleaning surfaces. First, a cleaning product applied as a gel provides a better contact between the surface to be cleaned and the cleaning product. Also, the contact time is typically longer with a gel since a gel flow less quickly on surfaces than a liquid. In addition, a cleaning product applied as a gel will, on average, result in product savings of about 15% compared to a liquid solution. A reduced use of cleaning product will also result in water savings and, therefore, in a substantial reduction of wastewater to be treated.

Experiments were carried out to confirm that potassium nitrate does not negatively affect viscosity. This was evaluated by measuring viscosity at various concentrations of the original products Versagel™ and Chloragel™ and comparing the viscosities with the modified versions containing different concentrations of potassium nitrate (i.e., NOA Soft Metal or NOA Original). In addition, impact of the water hardness water used for the diluting the products was also assessed.

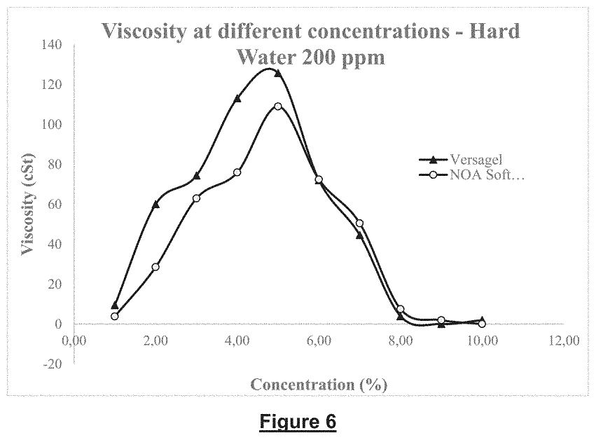

Viscosity tests were performed at 25° C. using an EZ Zahn™ Dip Viscosity Cup #2 according to the ASTM 4212 method. The viscosity measurements are depicted in FIGS. 6 to 8 as curves showing the measured viscosity versus concentration of the formulations. The measured viscosity values are expressed in centistoke (cSt) and these values have been corrected so that the lowest value is equal to 0 cSt.

Versagel™ vs. NOA Soft Metal

As shown In FIG. 6, in water having a hardness of 200 ppm, Versagel™ and NOA Soft Metal have a similar viscosity curves, with the greatest viscosity at about 5%. The maximum viscosity was 108 cSt for NOA Soft metal and 125 cSt for Versagel™, both at 5%.

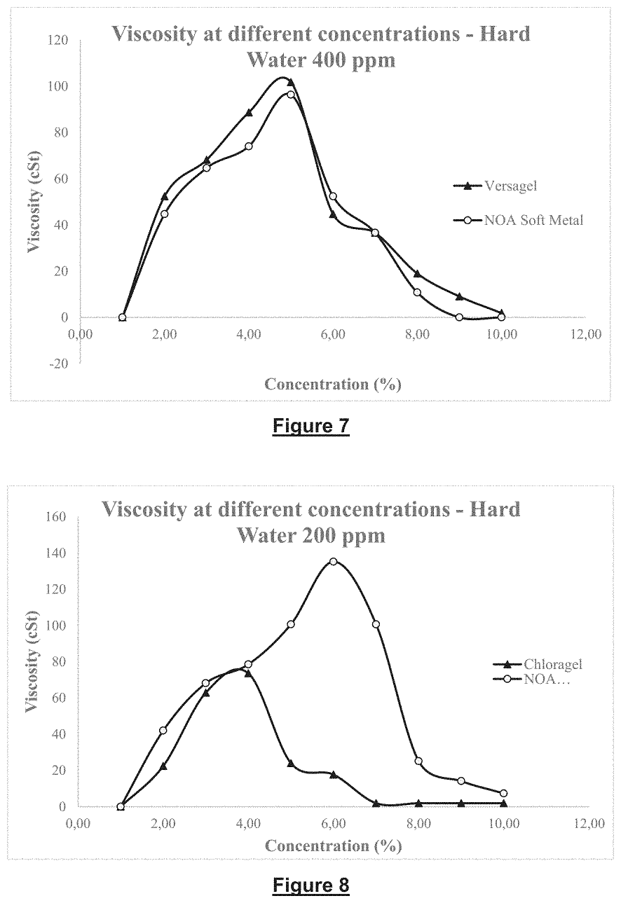

In water having a hardness of 400 ppm hardness, the viscosity curves of Versagel™ and NOA Soft Metal are, one again, very similar (FIG. 7). Also, maximum viscosity was once again reached at 5% (101 cSt for NOA Soft metal and 96 cSt for Versagel™)

Chloragel™ vs NOA Original

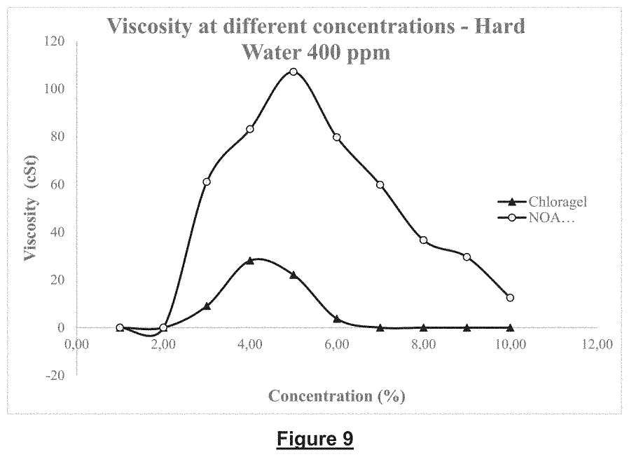

As shown in FIGS. 8 and 9, viscosity is quite different for Chloragel™ and NOA Original, both in water having a hardness of 200 ppm or 400 ppm.

Indeed, the product NOA Original possess a much higher viscosity compared to Chloragel™. Although both products have a similar viscosity at 3%, peak viscosity is achieved at a about 6% for the NOA Original. As shown on FIG. 8, peak viscosity is 73 cSt for the 4% Chloragel™ and 135 cSt for the 6% NOA Original. Shifting the peek of viscosity to higher concentrations is a huge advantage since this provides a better (i.e., more viscous) gel at higher concentrations.

In water having a hardness of 400 ppm, the difference is all the more blatant (see FIG. 9). Chloragel™ loses a lot of its viscosity at a concentration greater than about 4% (peak of about 28 cST), while NOA Original seems more insensitive to the hardness of the water used for its dilution since it maintains a viscosity greater than 40 cST between a range of concentrations about 3% to about 8%, with a peak of about 107 cST at about 5%. This is a great advantage since many food factories are located in rural areas where the water is often harder. Therefore, a gel in accordance with the present invention would still be very effective in locations where the water is hard.

Without being bound by any theory, it is predicted that difference in viscosity between Chloragel™ and NOA Original is mainly due to the fact that sodium hypochlorite has been replaced by potassium nitrate, thereby causing a substantial change in the ionic charges of the final formula. This is different from the earlier situation between Versagel™ and NOA Soft Metal, wherein no component was replaced and only potassium nitrate was added (see Table 5). Therefore, the ionic charge of both formulations remains similar, so is the viscosity.

### Example 3: Stability

The stability of the compositions of the invention was also tested. Briefly, the solutions were maintained for 8 weeks at different temperatures (−15° C., 4° C., 21° C. and 40° C.) in order to simulate accelerated aging conditions as well as for simulating winter conditions.

Although not shown, no deposition or phase shift was observed. Likewise, there was no variability in alkalinity, pH, or solid percentage during the 8-week study. Taken together, these results confirm that potassium nitrate does not negatively affect the long-term stability of the compositions of the invention, neither substantially changes the long-term stability of the original Chloragel™ and Versagel™ formulations.

### Example 4: Corrosion

The compositions of the invention were tested for their corrosive activity. Briefly, standardized plates of aluminum, stainless steel, copper and galvanized steel were immersed for 24 hours in 3% diluted solutions of Versagel™, NOA Soft Metal, Chloragel™ and NOA Original. After that incubation period, the plates were rinsed in deionized water, methanol then air dried and weighted to measure weight loss.

Results are presented in Table 7. Weight loss is expressed in mm lost per year (mm/year). No significant corrosion was observed on stainless steel for any of the formulations. Corrosion was observed on aluminum and galvanized steel for Chloragel™ and replacing the hypochlorite by potassium nitrate like in NOA original had not substantial impact on corrosion since the corrosive activity on these metals remained. Similar corrosion was also observed on galvanized steel for all the solutions, suggesting that potassium nitrate, while increasing the oxidative power of the solutions, had no particular impact in the original corrosion by the Chloragel™ and Versagel™ formulations.

TABLE 7
Corrosive activity*

| | Stainless | | | Galvanized |
|---|---|---|---|---|
| Products | steel | Aluminium | Copper | steel |
| Versagel ™ | 0.0000 | 0.0098 | 0.0140 | 0.8006 |
| NOA Soft Metal | 0.0000 | 0.0001 | 0.0131 | 0.7529 |
| Chloragel ™ | 0,0064 | 0.4313 | 0.0154 | 0.8262 |
| NOA Original | 0.0053 | 0.4615 | 0.0131 | 0.7838 |

*Weight loss expressed in mm lost per year (mm/year).

Headings are included herein for reference and to aid in locating certain sections. These headings are not intended to limit the scope of the concepts described therein, and these concepts may have applicability in other sections throughout the entire specification. Thus, the present invention is not intended to be limited to the embodiments shown herein but is to be accorded the widest scope consistent with the principles and novel features disclosed herein.

The singular forms “a”, “an” and “the” include corresponding plural references unless the context clearly dictates otherwise. Thus, for example, reference to “a compound” (e.g. “an alkaline agent”, “a surfactant”, etc.) includes one or more of such compounds and reference to “the method” includes reference to equivalent steps and methods known to those of ordinary skill in the art that could be modified or substituted for the methods described herein.

Unless otherwise indicated, all numbers expressing quantities of ingredients, reaction conditions, concentrations, properties, and so forth used in the specification and claims are to be understood as being modified in all instances by the term “about”. At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contains certain errors resulting from variations in experiments, testing measurements, statistical analyses and such.

It is understood that the examples and embodiments described herein are for illustrative purposes only and that various modifications or changes in light thereof will be suggested to persons skilled in the art and are to be included within the present invention and scope of the appended claims.

1. An aqueous degreasing composition, comprising:
(i) potassium nitrate; and
(ii) at least one alkaline agent.

2. The aqueous degreasing composition of claim 1, wherein the at least one alkaline agent is selected from the group consisting of sodium hydroxide (NaOH), potassium hydroxide (KOH), disodium metasilicate (Na₂SiO₃), ammonium hydroxide (NH₄OH), magnesium hydroxide (Mg(OH)₂), sodium tetraborate (Borax; Na₂[B₄O₅(OH)₄].8H₂O), sodium bicarbonate (NaHCO₃), sodium carbonate (Na₂CO₃), triethanolamine (C₆H₁₅NO₃), monoethanolamine (C₂H₇NO), calcium hydroxide (Ca(OH)₂), lithium hydroxide (LiOH) and ammonia (NH₃).

3. The aqueous degreasing composition of claim 1, wherein the composition comprises about 5% w/w to about 15% w/w of the at least one alkaline agent.

4. The aqueous degreasing composition of claim 1, wherein the composition comprises about 0.5% w/w to about 5% w/w potassium nitrate.

5. The aqueous degreasing composition of claim 1, wherein the composition further comprises at least one compound selected from the group consisting of a surfactant, an anti-redeposition agent, a rheology agent, a foaming agent, an anti-corrosive agent, and a bactericide.

6. The aqueous degreasing composition of claim 5, wherein the surfactant is selected from the group consisting of sulfonic acid, sodium xylene sulfonate, N,N-dimethyltetradecylamine N-oxide, and dodecylbenzenesulphonic acid.

7. The aqueous degreasing composition of claim 5, wherein the composition comprises about 5% w/w to about 20% w/w surfactant.

8. The aqueous degreasing composition of claim 5, wherein the anti-redeposition agent is selected from the group consisting of poly(acrylic acid sodium salt), sodium carboxymethyl cellulose (CMC), methylcellulose, polyvinylpyrrolidone (PVP), polyvinyl alcohol, polyethylene glycol (PEG), polyacrylic acid polymer, and acrylic/maleic co-polymer.

9. The aqueous degreasing composition of claim 5, wherein the composition comprises about 2.0% w/w to about 10.0% w/w of the anti-redeposition agent.

10. The aqueous degreasing composition of claim 5, wherein the anti-redeposition agent comprises a liquid detergent polymer.

11. The aqueous degreasing composition of claim 1, wherein said degreasing composition takes the form of a gel.

12. The aqueous degreasing composition of claim 11, wherein said gel comprises a viscosity of at least 50 centistoke (cSt), in water having 200 ppm hardness and a viscosity of at least 50 centistoke (cSt) in water having 400 ppm hardness.

13. The aqueous degreasing composition of claim 1, wherein said degreasing composition is chlorine-free.

14. The aqueous degreasing composition of claim 1, wherein said degreasing composition is free of sodium hypochlorite, calcium hypochlorite, chlorine dioxide, sodium dichloroisocyanurate, and trichloroisocyanuric acid.

15. An aqueous degreasing composition comprising:
(i) about 0% w/w to about 30 w/w anti-redeposition agent;
(ii) about 0.1% w/w to about 50 w/w of at least one alkaline agent;
(iii) about 0.01% w/w to about 50% w/w surfactant(s);
(iv) about 0.01% w/w to about 35% w/w potassium nitrate; and
(v) demineralized water to complete to 100% w/w.

16. The aqueous degreasing composition of claim 15, comprising:
(i) about 1% w/w to about 5% w/w anti-redeposition agent;
(ii) about 4% w/w to about 7% w/w of at least one alkaline agent;
(iii) about 7% w/w to about 12% w/w surfactant(s);
(iv) about 1% w/w to about 3% w/w potassium nitrate; and
(v) demineralized water to complete to 100% w/w.

17. An aqueous degreasing composition consisting of:
(i) about 1% w/w to about 5% w/w anti-redeposition agent;
(ii) about 4% w/w to about 7% w/w of at least one alkaline agent;
(iii) about 7% w/w to about 12% w/w surfactant(s);
(iv) about 1% w/w to about 3% w/w potassium nitrate; and
(v) demineralized water to complete to 100% w/w.

18. An aqueous degreasing composition comprising:
(i) about 0.01% w/w to about 35% w/w potassium nitrate;
(ii) about 0.01% w/w to about 50 w/w alkaline agent(s);
(iii) about 0.01% w/w to about 50% w/w surfactant(s);
(iv) about 0% w/w to about 16% w/w sequestrant(s);
(v) about 0% w/w to about 5% w/w dispersant(s); and
(vi) demineralized water to complete to 100% w/w.

19. The aqueous degreasing composition of claim 18, comprising:
(i) about 1% w/w to about 3% w/w potassium nitrate;
(ii) about 8% w/w to about 12 w/w alkaline agent(s);
(iii) about 12% w/w to about 16% w/w surfactant(s);
(iv) about 0.5% w/w to about 2% w/w sequestrant(s);
(v) about 0.5% w/w to about 2% w/w dispersant(s); and
(vi) demineralized water to complete to 100% w/w.

20. An aqueous degreasing composition consisting of:
(i) about 1% w/w to about 3% w/w potassium nitrate;
(ii) about 8% w/w to about 12 w/w alkaline agent(s);
(iii) about 12% w/w to about 16% w/w surfactant(s);
(iv) about 0.5% w/w to about 2% w/w sequestrant(s);
(v) about 0.5% w/w to about 2% w/w dispersant(s); and
(vi) demineralized water to complete to 100% w/w.

21. A method of degreasing a surface, comprising contacting said surface with an aqueous degreasing composition as defined in claim 1.

22. A method of degreasing an enclosed surface of a piping system, the method comprising circulating into said piping system a degreasing composition according to claim 1, wherein said circulating is carried out for a period of time providing for removal of fats and proteins from said enclosed surface.

23. The method of claim 22, wherein said circulating is carried out for at least 10 minutes.

24. The method of claim 22, further comprising rinsing said piping system with water after said circulating.
